(19) United States
(12) Patent Application Publication
(10) Pub. No.: US 2014/0239957 A1
(43) Pub. Date: Aug. 28, 2014

(54) Using Low Frequency For Detecting Formation Structures Filled With Magnetic Fluid

(71) Applicants: Ping Zhang, Albany, CA (US); David L. Alumbaugh, Berkeley, CA (US); Michael Wilt, Walnut Creek, CA (US)

(72) Inventors: Ping Zhang, Albany, CA (US); David L. Alumbaugh, Berkeley, CA (US); Michael Wilt, Walnut Creek, CA (US)

(73) Assignee: SCHLUMBERGER TECHNOLOGY CORPORATION, Sugar Land, TX (US)

(21) Appl. No.: 14/233,345

(22) PCT Filed: Jul. 9, 2012
(86) PCT No.: PCT/US2012/047266

§ 371 Date: Mar. 26, 2014

Related U.S. Application Data
(60) Provisional application No. 61/509,486, filed on Jul. 19, 2011.

(51) Int. Cl. G01V 3/30

(52) U.S. Cl. CPC G01V 3/30
USPC 324/334

(57) ABSTRACT

A method for mapping a subterranean formation having an electrically conductive wellbore casing therein may include using a low frequency electromagnetic (EM) transmitter and EM receiver operating at a low frequency of less than or equal to 10 Hertz to perform a first EM survey of the subterranean formation, and with either the low frequency EM transmitter or EM receiver within the electrically conductive well-bore casing. The method may further include injecting a magnetic fluid into the subterranean formation, and using the low frequency EM transmitter and EM receiver to perform a second EM survey of the subterranean formation after injecting the magnetic fluid.

### BACKGROUND

Magnetic fluids have been applied in many different technologies, such as electronic devices, aerospace, medicine and heat transfer. In the oil and gas industry, magnetic fluids have been used in mapping fracture zones.

Magnetic particle tracers injected into the fractures of the earth crust is disclosed in U.S. Pat. No. 5,151,658 to Muramatsu et al. and titled “Three-Dimensional Detection System For Detecting Fractures And Their Distributions In The Earth Crust Utilizing An Artificial Magnetic Field And Magnetic Particle Tracer.” Similarly, the following references disclose the use of magnetic fluids in imaging hydrocarbon reservoirs: International Publication No. WO2009/142779 to Schmidt et al. and titled “Methods For Magnetic Imaging Of Geological Structures;” and International Publication No. WO2008/153656 to Ameen and titled “Method Of Characterizing Hydrocarbon Reservoir Fractures In Situ With Artifically Enhanced Magnetic Anistropy.”

Various methods and tools have been used to determine the electrical resistivity of geologic formations surrounding and between boreholes. Tools and methods sensitive to inter-well formation structures are referred to as “deep reading” to indicate a monitoring of resistivity in formations away from the immediate surroundings of a single borehole.

Deep-reading electromagnetic field surveys of subsurface areas typically involve large scale measurements from the surface, from surface-to-borehole, and/or between boreholes. Deep reading tools and methods are designed to measures responses of the reservoir on a scale equivalent to a few percent of the distances between boreholes. This is in contrast to the established logging methods, which are confined to the immediate vicinity of the boreholes, i.e., typically within a radial distance of one meter or less.

Deep reading methods are applied for determining parameters of the formation at a distance of 10 meters or more up to hundreds of meters from the location of the sensors. Field electromagnetic data sense the reservoir and surrounding media in this large scale sense.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

A method for mapping a subterranean formation having an electrically conductive wellbore casing therein is provided herein which may include using a low frequency electromagnetic (EM) transmitter and EM receiver operating at a low frequency of less than or equal to 10 Hertz to perform a first EM survey of the subterranean formation. Either the low frequency EM transmitter or EM receiver are within the electrically conductive wellbore casing. The method may further include injecting a magnetic fluid into the subterranean formation, and using the low frequency EM transmitter and EM receiver to perform a second EM survey of the subterranean formation after injecting the magnetic fluid.

A related apparatus for mapping a subterranean formation having an electrically conductive wellbore casing therein may include a low frequency EM transmitter and EM receiver to operate at a low frequency of less than or equal to 10 Hertz, and with either the low frequency EM transmitter or EM receiver to be positioned within the electrically conductive wellbore casing. The apparatus may further include an injector to inject a magnetic fluid into the subterranean formation, and a mapping device to use the low frequency EM transmitter and EM receiver to perform a first EM survey of the subterranean formation prior to injecting the magnetic fluid, and a second EM survey of the subterranean formation after injecting the magnetic fluid.

### BRIEF DESCRIPTION OF THE DRAWINGS

FIG. 1 is a schematic block diagram of an example embodiment of an apparatus for mapping a subterranean formation using a low frequency EM transmitter and EM receiver in a borehole-to-borehole configuration.

FIG. 2 is a schematic block diagram of an example embodiment of an injector used to inject a magnetic fluid into the subterranean formation illustrated in FIG. 1.

FIG. 3 is a flow diagram illustrating a method for mapping a subterranean formation using a low frequency EM transmitter and EM receiver.

FIG. 4 is a schematic block diagram of another example embodiment of an apparatus for mapping a subterranean formation using a low frequency EM transmitter and EM receiver in a borehole-to-surface configuration.

FIG. 5 is a schematic block diagram of still another example embodiment of an apparatus for mapping a subterranean formation using a low frequency EM transmitter and EM receiver in a surface-to-borehole configuration.

FIG. 6 is a schematic block diagram of a model used to simulate borehole-to-borehole EM responses to a magnetically enhanced formation.

FIG. 7 is a plot of a calculated sensitivity from a transmitter in a wellbore without a casing for an injection region having an injected fluid.

FIG. 8 is a plot of a calculated sensitivity for from a transmitter in a wellbore with a casing for an injection region having an injected fluid.

FIG. 9 is a plot of a calculated sensitivity from a transmitter in a wellbore without a casing for a larger sized injection region as compared to FIG. 7.

FIG. 10 is a plot of a calculated sensitivity for from a transmitter in a wellbore with a casing for a larger sized injection region as compared to FIG. 8.

FIG. 11 is a schematic block diagram of another model embodiment used to simulate borehole-to-borehole EM responses to a magnetically enhanced formation.

FIG. 12 is a plot of a calculated sensitivity from a transmitter in a wellbore without a casing for an injection region 10 m from the transmitter wellbore.

FIG. 13 is a plot of a calculated sensitivity for from a transmitter in a wellbore with a casing for an injection region 10 m from the transmitter wellbore.

FIG. 14 is a plot of a calculated sensitivity from a transmitter in a wellbore without a casing for an injection region 20 m from the transmitter wellbore.

FIG. 15 is a plot of a calculated sensitivity for from a transmitter in a wellbore with a casing for an injection region 20 m from the transmitter wellbore.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime and multiple prime notations are used to indicate similar elements in different embodiments.

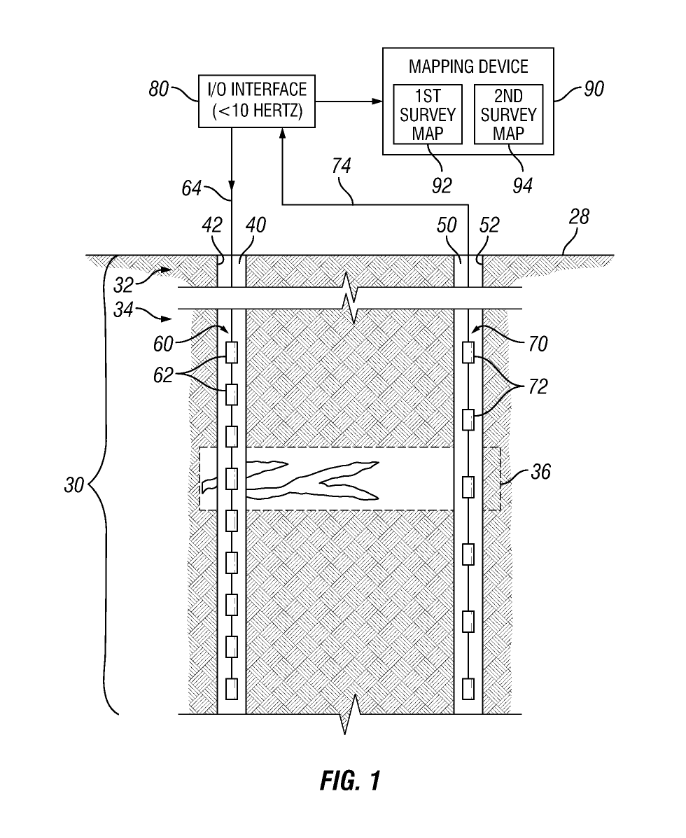

Referring initially to FIGS. 1-3, an apparatus 20 and related method for mapping a subterranean formation 30 having electrically conductive wellbore casings 42, 52 therein are first described. In the illustrated borehole-to-borehole configuration, a pair of wellbores 40, 50 extend into the subterranean formation 30, which illustratively includes one or more upper layers 32 (e.g., topsoil, aquifer layer, etc.) and a reservoir layer(s) 34 (e.g., a rock or limestone layer, etc.) where a hydrocarbon resource 36 is located. The electrically conductive wellbore casing 42 is in wellbore 40, and the electrically conductive wellbore casing 52 is in the other wellbore 50.

A low frequency electromagnetic (EM) transmitter 60 is in the electrically conductive wellbore casing 42, and a low frequency EM receiver 70 is in the other electrically conductive wellbore casing 52. The low frequency EM transmitter and EM receiver 60, 70 both operate at a low frequency of less than or equal to 10 Hertz. The low frequency EM transmitter 60 may include a plurality of EM transmitter devices 62 deployed via a wireline 64. Similarly, the low frequency EM receiver 70 may include a plurality of EM receiver devices 72 deployed via a wireline 74.

The low frequency EM transmitter 60 and EM receiver 70 may be coupled to an input/output interface module 80 that operates at the same low frequency of less than or equal to 10 Hertz. A mapping device 90 uses the low frequency EM transmitter 60 and EM receiver 70 to perform a first EM survey of the hydrocarbon resource 36 in the subterranean formation 30 prior to injecting a magnetic fluid 102 therein. The mapping device 90 thus generates a first EM survey map 92 as an initial baseline.

By operating the low frequency EM transmitter 60 and EM receiver 70 at a low frequency of less than or equal to 10 Hertz, the electrically conductive wellbore casings 42, 52 do not adversely effect the EM signals transmitted by the EM transmitter 60 or received by the EM receiver 70. In another example embodiment, the low frequency EM transmitter 60 and EM receiver 70 operate at a low frequency of less than or equal to 5 Hertz.

When operating above 10 Hertz, the effects of the electrically conductive wellbore casings 42, 52 need to be taken into account. Known techniques to compensate for the effects of the electrically conductive wellbore casings 42, 52 on EM signals are disclosed in U.S. Pat. Nos. 6,294,917 and 7,565,244 which are commonly assigned to the current assignee, and which are incorporated herein by reference.

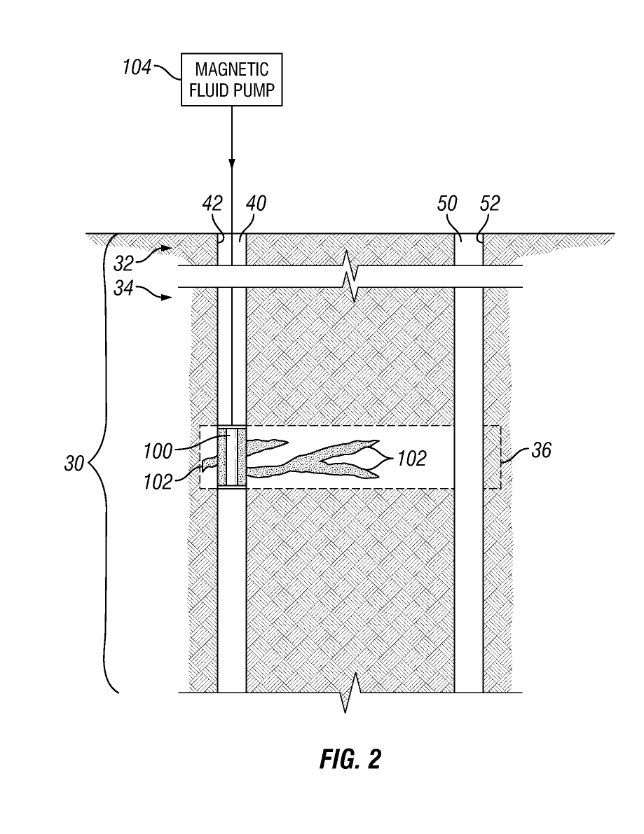

After generation of the first EM survey map 92, the low frequency EM transmitter 60 is removed from the wellbore 40 so that an injector 100 may be inserted therein, as illustrated in FIG. 2. The injector 100 may be connected to a magnetic fluid pump 104. The injector 100 may inject a magnetic fluid 102 though holes in the electrically conductive wellbore casing 42, for example, to enter the hydrocarbon resource 36 in the subterranean formation 30. More particularly, the electrically conductive wellbore casing 42 allows a desired interval in the wellbore 40 to be pressure-isolated, and perforations in the casing in the interval of interest allow the magnetic fluid 102 to be introduced at that location.

Alternatively, the injector 100 may be placed in the other wellbore 50 after removal of the low frequency EM receiver 70. In lieu of the injector 100 being placed within one of the wellbores 40 or 50, the injector may have its own wellbore to allow injection of the magnetic fluid 102 into the hydrocarbon resource 36 in the subterranean formation 30.

After injection of the magnetic fluid 102 into the hydrocarbon resource 36 in the subterranean formation 30, the low frequency EM transmitter 60 and EM receiver 70 are used by the mapping device 90 to perform a second EM survey. The mapping device 90 thus generates a second EM survey map 94 which may then be compared to the first EM survey map 92. The mapping device 90 compares the first and second EM survey maps 92, 94 to provide a mapping of the hydrocarbon resource 36 in the subterranean formation 30.

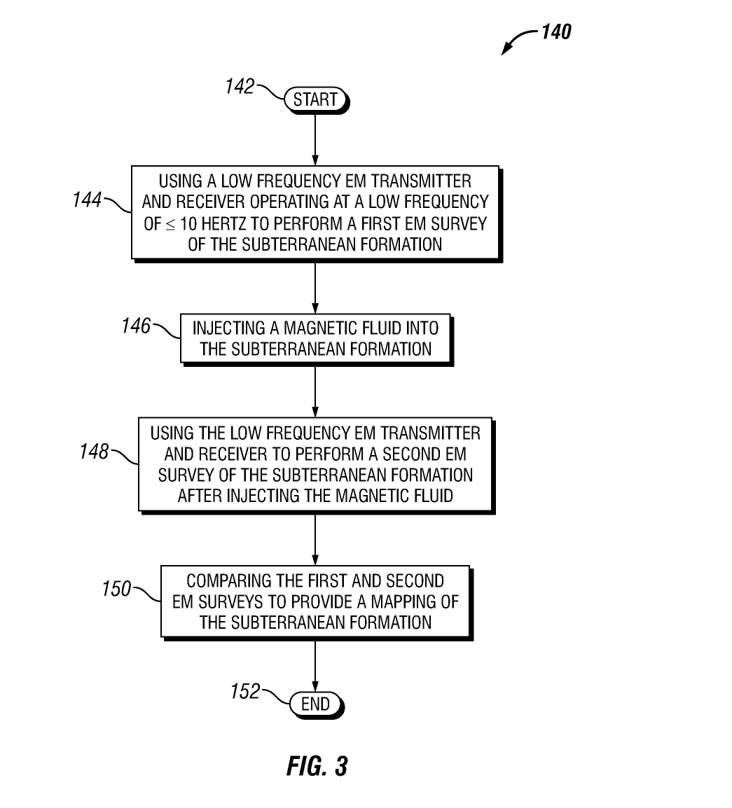

A flow diagram 140 illustrating a method for mapping a subterranean formation 30 using a low frequency EM transmitter and EM receiver will now be discussed in reference to FIG. 3. From the start (Block 142), the method comprises using a low frequency EM transmitter 60 and EM receiver 70 operating at a low frequency of less than or equal to 10 Hertz to perform a first EM survey of the subterranean formation 30 at Block 144. The low frequency EM transmitter 60 or the low frequency EM receiver 70 may be within the electrically conductive wellbore casing 40. The method further includes injecting a magnetic fluid 102 into the subterranean formation 30 at Block 146, and using the low frequency EM transmitter 60 and EM receiver 70 to perform a second EM survey of the subterranean formation 30 after injecting the magnetic fluid 102 at Block 148 to provide a mapping of the hydrocarbon resource 36 in the subterranean formation 30. The method ends at Block 152.

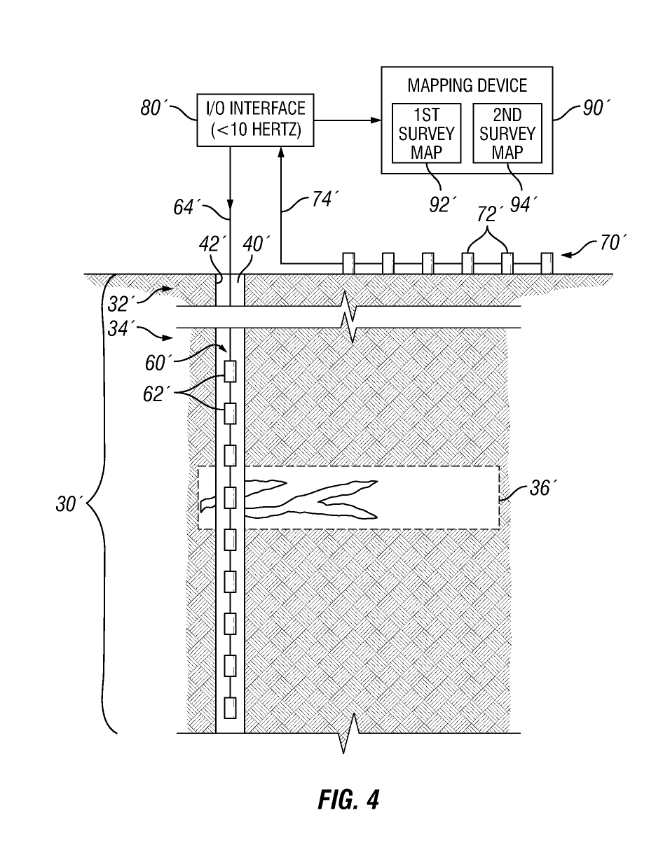

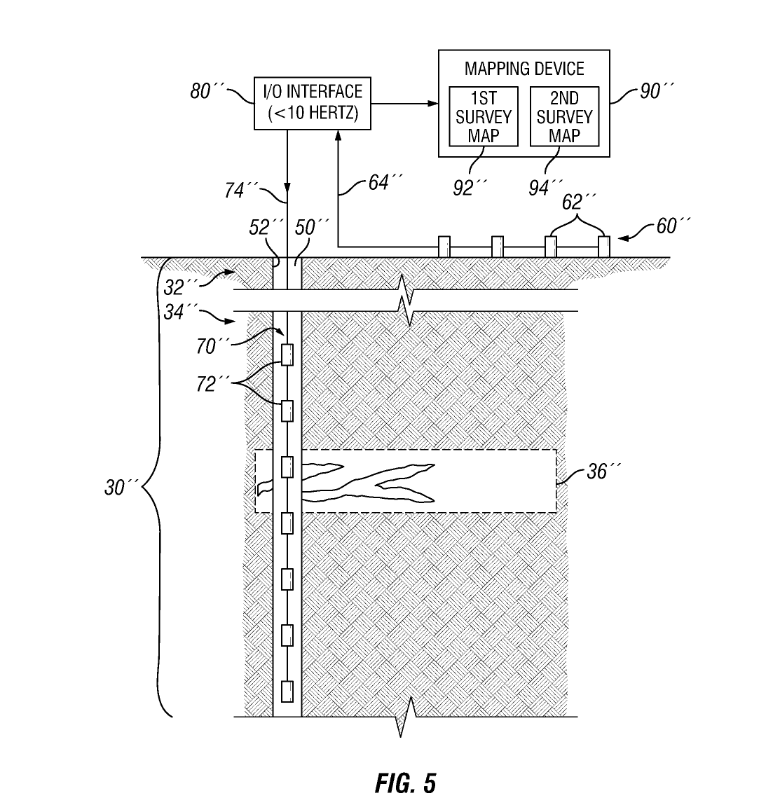

In another example embodiment, the low frequency EM transmitter 60′ remains in the wellbore 40′ but the low frequency EM receiver 70′ is on the surface for a borehole-to-surface configuration, as illustrated in FIG. 4. In still another example embodiment, the low frequency EM transmitter 60″ is on the surface while the low frequency EM receiver 70″ remains in the wellbore 50″ for a surface-to-borehole configuration, as illustrated in FIG. 5.

Although the surface 28, 28′ and 28″ is shown in FIGS. 1, 4 and 5 as being a land surface, according to some embodiments, the region above the surface can be water as in the case of marine applications. For example, for the borehole-to-surface and surface-to-borehole configurations as shown in FIGS. 4 and 5, respectively, surface 28′ is the sea floor and the low frequency EM receiver 70′ and the low frequency EM transmitter 60″ are deployed from a vessel.

In view of the above-described apparatus and methods, injecting a magnetic fluid 102 into an oil well is helpful to monitor where the injected magnetic fluid migrates. Often, the injected magnetic fluid 102 has a higher magnetic permeability than the oil it is replacing, which provides an opportunity to use a DeepLook Electro Magnetic Tool (Deeplook EM™), as provided by Schlumberger, the current assignee, to track the injected magnetic fluid 102 and delineate the related fractures and the oil/water contact.

Conventional logging is restricted to the near-wellbore volume, but Deeplook EM™ illuminates the wider reservoir volume with an EM transmitter deployed in one wellbore and an EM receiver deployed in another wellbore. EM imaging can be conducted between two wells located up to 1,000 meters apart, depending on the well completions and the formation and resistivity contrasts. A typical range of the operating frequency of the EM transmitter and EM receiver is from 5-1,000 Hertz, for example.

Mapping conductive fluids in this way requires either injection of current into the formation through electrodes, or the use of a time varying magnetic field to induce currents in the fluids. The magnitude of the induced currents in the latter case depends on the frequency that is employed, with higher frequencies yielding larger currents, and therefore, larger scattered fields. However, most wellbores are cased with a steel pipe that severely limits the applicable frequency range.

Recent studies funded through the Advanced Energy Consortium (AEC) have indicated the possibility of creating a magnetically enhanced fluid thought the use of magnetic nano-particles. Usually, the relative magnetic permeability (μᵣ) of fluids is unity. However, recent laboratory studies have indicated that bulk-rock magnetic permeabilities as high as 10 may be achievable through the use of nano-particle materials. The nano-particles typically have dimensions of less than or equal to 100 nm.

The fact that a magnetically enhanced fluid could produce an anomalous response even at zero frequency opens up the possibility of using low frequency DeepLook EM™ measurements which has the benefit of the fields not being as affected by the steel casings as it would at higher frequencies if electromagnetic induction where required as it is for imaging an electrically conductive fluid.

With DeepLook EM™ surveys, a series of electrical/ magnetic transmitter devices and receiver devices are deployed within the wellbores or on the surface/sea bottom. The transmitter devices broadcast an EM signal, usually a sinusoid or a square wave, through the earth to be detected by the receiver devices. The galvanic and EM coupling from the measurements may provide formation resistivity imaging from the wellbore outwards into the reservoir.

The transmitter devices can either be a grounded wire type or a magnetic dipole. Grounded wires are desirable for surface-to-borehole applications. Magnetic dipoles are normally placed inside wellbores for cross-well applications (receiver devices are placed in another wellbore), borehole-to-surface applications (receiver devices are placed on the surface/sea bottom) and single well applications (receiver devices are placed in the same wellbore as the transmitter devices). Although the following analysis is directed to a borehole-to-borehole application, the same results can be acquired for the other survey applications.

Receivers are either electric or magnetic field detectors, and can measure the field in one to three Cartesian directions. The magnetic dipole receivers have lower sensitivities to the resistive (oil bearing) structures, but can be placed inside a steel casing. The resulting casing effects can be removed using the above techniques that are incorporated herein by reference.

The electric dipole receivers are more sensitive to the resistive structures and are preferred sensors for hydrocarbon and by-passed pay detection, but cannot be placed inside steel casing. The highly conductive property of the steel casing prevents any EM field from the transmitter reaching the receiver inside. An alternative way is to put the electric dipole receivers below a steel casing. It is not uncommon that the steel casing is stopped above a potential target which opens the opportunity for wireline measurements of the electric fields.

To study the possibility of detecting formation structures 36 filled with magnetic fluid 102, the CWNLAT algorithm has been employed to simulate borehole-to-borehole EM responses to a magnetically enhanced formation. Developed by Schlumberger-Doll Research, CWNLAT is a finite element code that simulates EM tool responses inside a wellbore with or without a conductive casing.

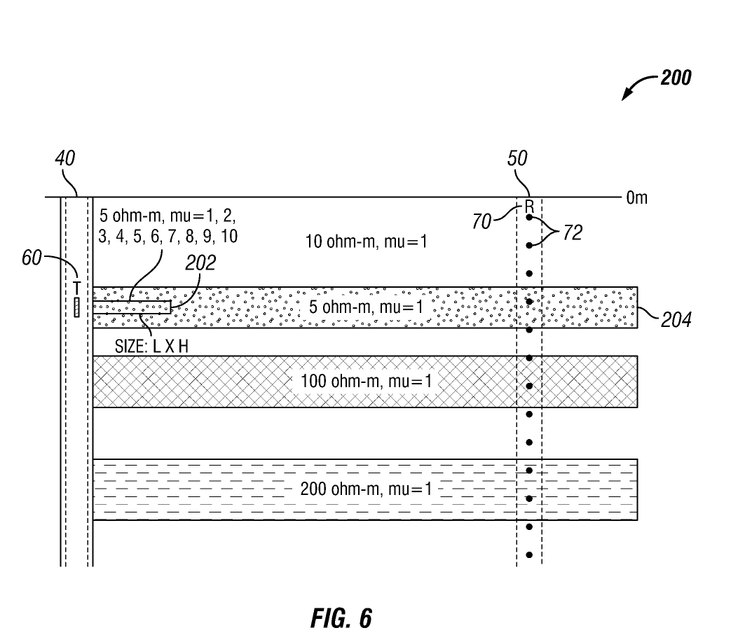

The code assumes an axially symmetric model and source excitation, and allows the casing and formation to be characterized and simulated by its conductivity (σ), relative dielectric permittivity (εᵣ) and relative magnetic permeability (μᵣ). The modeling steps are as follows: 1) create a background model 200 as illustrated in FIG. 6; 2) model the injected fluid as a donut-shaped region 202 that has the same conductivity (σ) but different relative magnetic permeability (μᵣ) as the host layer 204. Due to the low frequency nature of the measurements, the relative dielectric permittivity (εᵣ) is set to one; 3) calculate the magnetic fields at 5 Hz, which is the lowest useable frequency for the DeepLook EM™ system with and without the injection region, and with and without a steel casing; and 4) calculate the relative sensitivity with and without a steel casing as described below.

Still referring to FIG. 6, the injected magnetic fluid is modeled as a donut shaped region 202, although in the figure it appears as a rectangular block, with the same conductivity (5 ohm-m) as the host layer 204, but a range of relative magnetic permeabilities (1 to 10). The transmitter 60 is located in one wellbore 40 that is either cased or uncased, and the receiver devices 72 are located in a second uncased wellbore 50 200 meters away from the transmitter. The frequency used for the simulation is 5 Hertz. For the cased wellbore, the casing geometry and physical properties are an inner diameter=8 inch; casing thickness=0.4 inch; σ=5c6S/m and μᵣ=100. After calculating the cross-well magnetic fields, the relative sensitivity is defined as:

s=100*(Hμᵣ−Hμᵣ₌₁)/Hμᵣ₌₁ (1)
Hμᵣ: cross-well magnetic field calculated with μᵣ>1 for the injecting fluid; and
Hμᵣ₌₁: cross-well magnetic field calculated with μᵣ=1 for the injecting fluid.

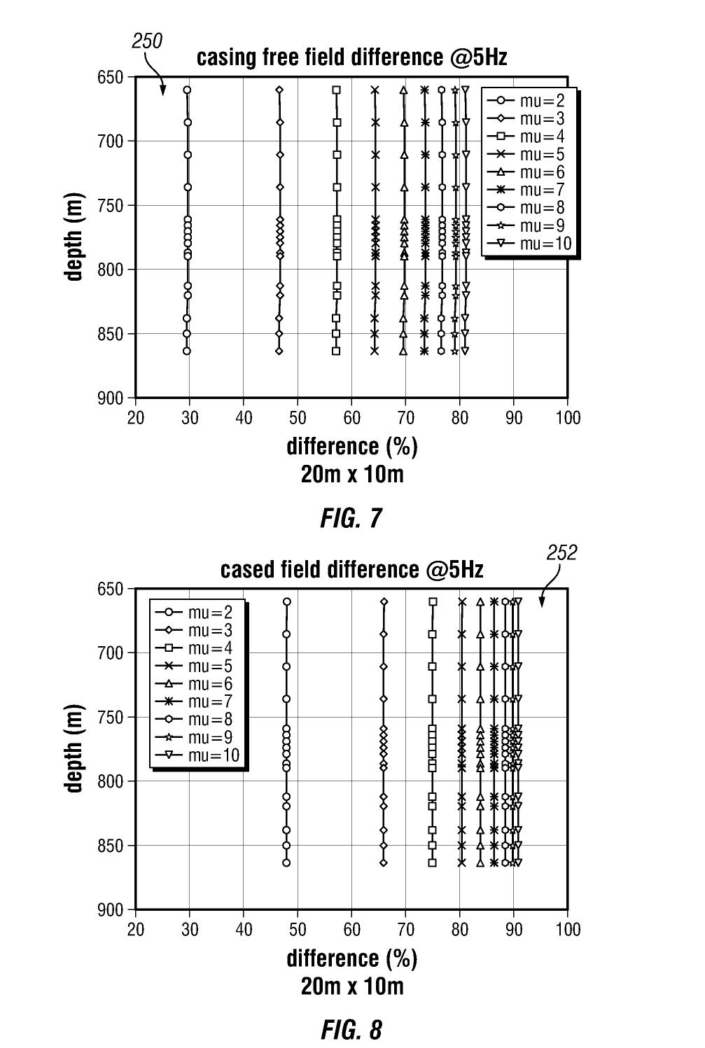

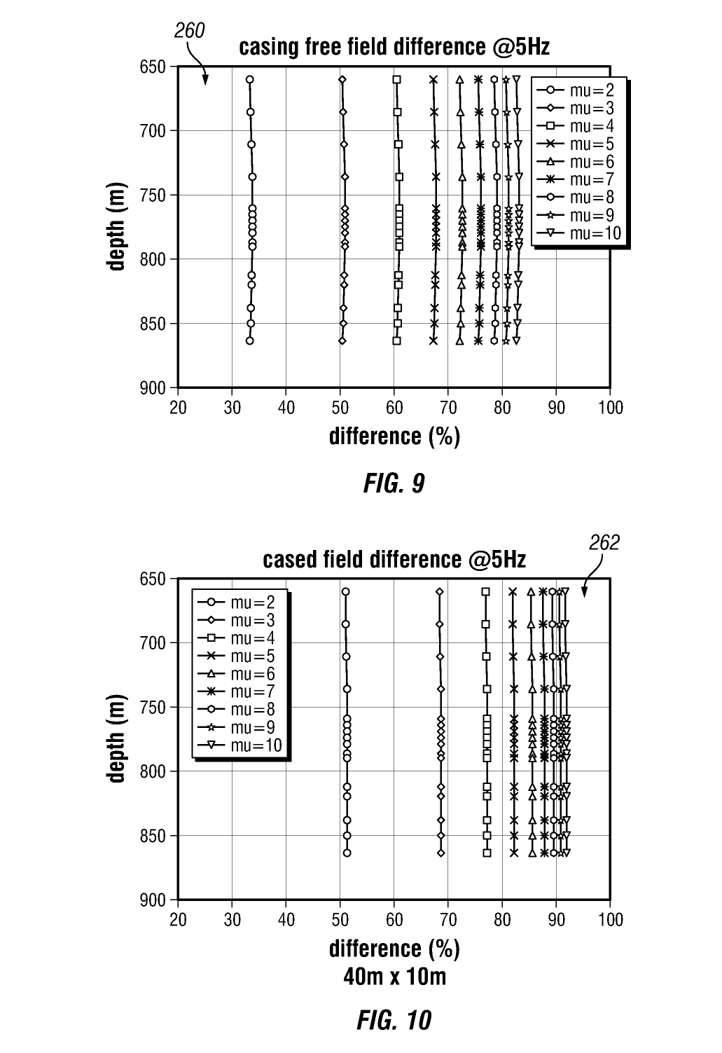

FIGS. 7-10 show the calculated sensitivity for the injected fluid from the transmitter wellbore. The plots 250, 252 in FIGS. 7 and 8 are the sensitivity for the fluid size of 20 m (length)×10 m (thickness). Plot 250 is the result for an uncased well, and the other plot 252 is for a cased well. Similar results from a larger injection region (40 m×10 m) are presented by plots 260, 262 in FIGS. 9 and 10. Excellent sensitivities (up to 90%) are observed in both cases. The steel casing does not degrade the sensitivity, in fact, somewhat higher sensitivity is observed for the cased wellbore.

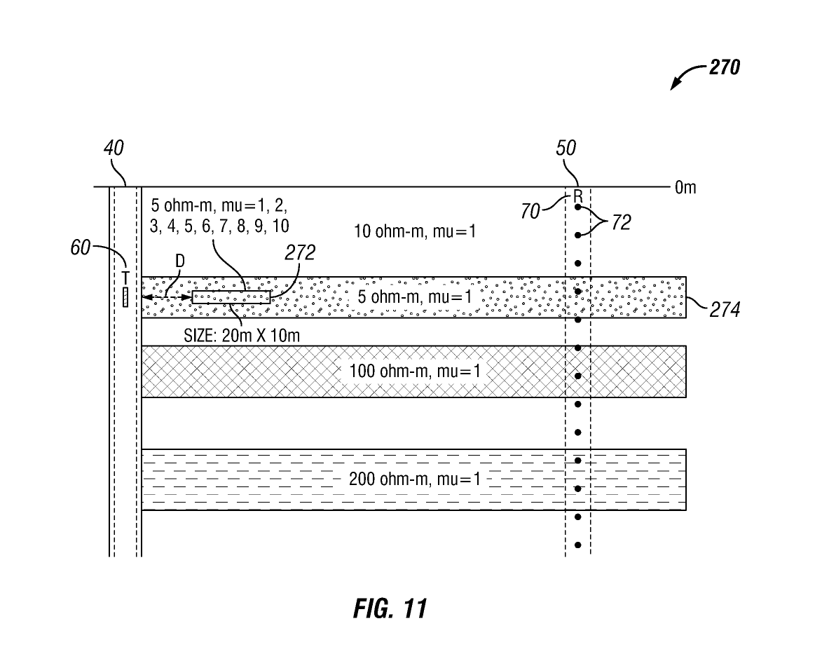

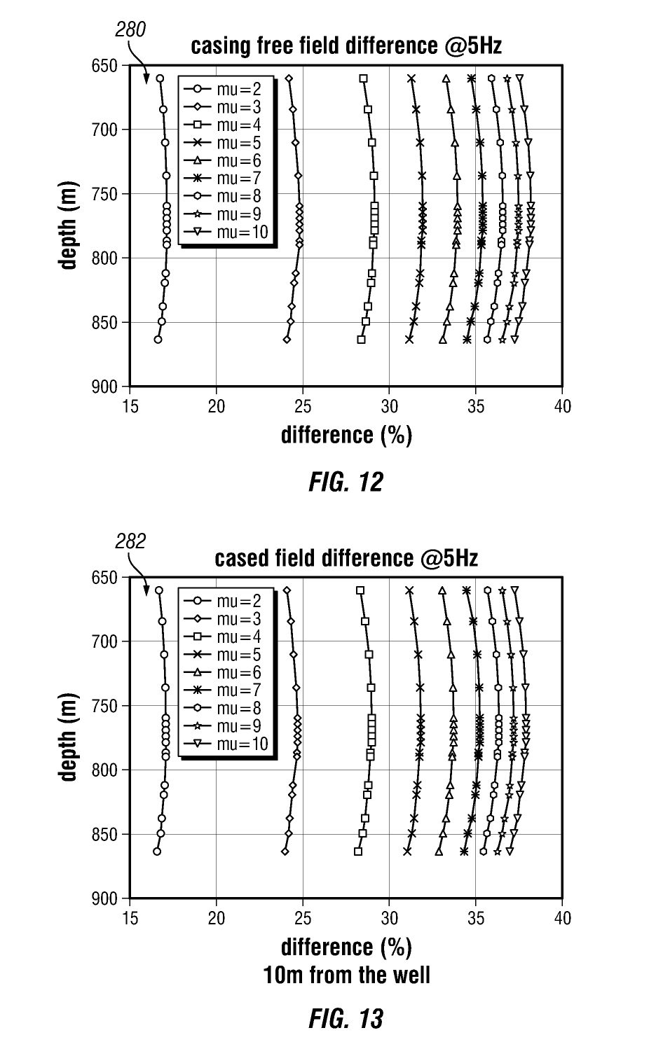

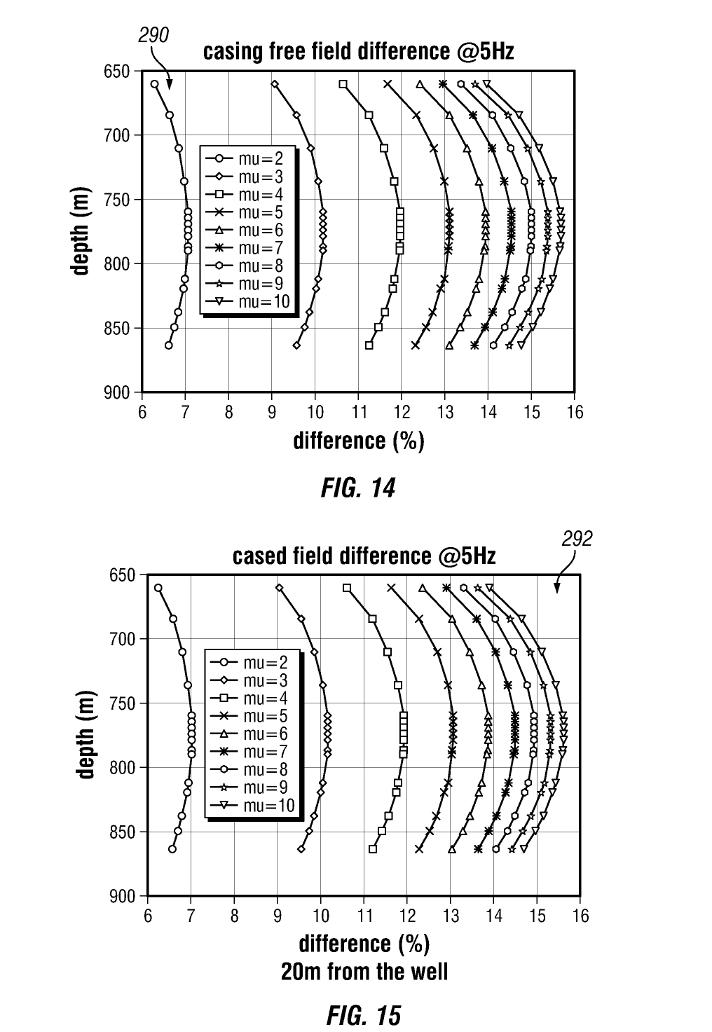

Next, while referring to FIGS. 11-15, the sensitivity of the method to a pulse of magnetized fluid that is gradually increasing in diameter examined. This is accomplished in the modeling by keeping the cross-section of the injection region 272 the same size (i.e. 20 m×10 m), but allowing the radius to the inner edge of the injection zone to expand outward away from the transmitter well 40, as shown in FIG. 11. It is observed that as the ring moves outward the sensitivity is reduced. FIGS. 12-15 shows the sensitivity plots when the inner radius of the ring of fluid is 10 m (FIGS. 12-13) and 20 m (FIGS. 14-15) away from the transmitter well. For 10 m, plot 280 is the result for an uncased well, and the other plot 282 is for a cased well. For 20 m, plot 290 is the result for an uncased well, and the other plot 292 is for a cased well.

While the maximum sensitivities are reduced to 38% (10 m away) and 15% (20 m away), they are still large enough to be detected. These observations provide a practical method for detecting the extent of injection using the following series of steps: 1) step 1—perform a DeepLook-EM™ survey (single well, cross-well, surface-to-borehole or borehole-to-surface) before injecting magnetic fluid into the formation. 2) step 2—inject the magnetic fluid into the target zones (fracture zones or hydrocarbon reservoirs) and perform DeepLook-EM™ surveys again. 3) step 3—perform data analysis and inversions to define the extent of the injection zone.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the disclosure.

That which is claimed is:

1. A method for mapping a subterranean formation having an electrically conductive wellbore casing therein, the method comprising:
using a low frequency electromagnetic (EM) transmitter and EM receiver operating at a low frequency of less than or equal to 10 Hertz to perform a first EM survey of the subterranean formation, and with either the low frequency EM transmitter or EM receiver within the electrically conductive wellbore casing;
injecting a magnetic fluid into the subterranean formation; and
using the low frequency EM transmitter and EM receiver to perform a second EM survey of the subterranean formation after injecting the magnetic fluid.

2. A method according to claim 1 further comprising comparing the first and second EM surveys to provide a mapping of the subterranean formation.

3. A method according to claim 1 wherein the low frequency EM transmitter and EM receiver operate at a low frequency of less than or equal to 5 Hertz.

4. A method according to claim 1 wherein the magnetic fluid comprises nano-particles having dimensions of less than or equal to 100 nm.

5. A method according to claim 4 wherein the magnetic fluid has a magnetic permeability (μᵣ) of less than or equal to 10.

6. A method according to claim 1 wherein the low frequency EM transmitter is in the borehole and the low frequency EM receiver is on a surface above the subterranean formation.

7. A method according to claim 1 wherein the low frequency EM receiver is in the borehole and the low frequency EM transceiver is on a surface above the subterranean formation.

8. A method according to claim 1 wherein the low frequency EM transmitter is in the borehole and the low frequency EM receiver is an adjacent borehole.

9. A method according to claim 1 wherein the low frequency EM transmitter comprises a plurality of spaced apart transmitter devices deployed via a wireline.

10. A method according to claim 1 wherein the low frequency EM receiver comprises a plurality of spaced apart receiver devices deployed via a wireline.

11. A method for mapping a subterranean formation having an electrically conductive wellbore casing therein, the method comprising:
using a low frequency electromagnetic (EM) transmitter and EM receiver operating at a low frequency of less than or equal to 5 Hertz to perform a first EM survey of the subterranean formation, and with either the low frequency EM transmitter or EM receiver within the electrically conductive wellbore casing;
injecting a magnetic fluid into the subterranean formation, the magnetic fluid comprising nano-particles having dimensions of less than or equal to 100 nm; and
using the low frequency EM transmitter and EM receiver to perform a second EM survey of the subterranean formation after injecting the magnetic fluid.

12. A method according to claim 11 further comprising comparing the first and second EM surveys to provide a mapping of the subterranean formation.

13. A method according to claim 11 wherein the magnetic fluid has a magnetic permeability (μᵣ) of less than or equal to 10.

14. An apparatus for mapping a subterranean formation having an electrically conductive wellbore casing therein, the apparatus comprising:
a low frequency electromagnetic (EM) transmitter and receiver to operate at a low frequency of less than or equal to 10 Hertz, and with either the low frequency EM transmitter or receiver to be positioned within the electrically conductive wellbore casing;
an injector to inject a magnetic fluid into the subterranean formation; and
a mapping device to use said low frequency EM transmitter and receiver to perform a first EM survey of the subterranean formation prior to injecting the magnetic fluid, and a second EM survey of the subterranean formation after injecting the magnetic fluid.

15. An apparatus according to claim 14 wherein said mapping device comprises the first and second EM surveys to provide a mapping of the subterranean formation.

16. An apparatus according to claim 14 wherein said low frequency EM transmitter and EM receiver operate at a low frequency of less than or equal to 5 Hertz.

17. An apparatus according to claim 14 wherein the magnetic fluid comprises nano-particles having dimensions of less than or equal to 100 nm.

18. An apparatus according to claim 17 wherein the magnetic fluid has a magnetic permeability (μᵣ) of less than or equal to 10.

19. An apparatus according to claim 14 wherein said low frequency EM transmitter is in the borehole and said low frequency EM receiver is on a surface above the subterranean formation.

20. An apparatus according to claim 14 wherein said low frequency EM receiver is in the borehole and said low frequency EM transceiver is on a surface above the subterranean formation.

21. An apparatus according to claim 14 wherein said low frequency EM transmitter is in the borehole and said low frequency EM receiver is an adjacent borehole.

22. An apparatus according to claim 14 wherein said low frequency EM transmitter comprises a plurality of spaced apart transmitter devices deployed via a wireline.

23. An apparatus according to claim 14 wherein said low frequency EM receiver comprises a plurality of spaced apart receiver devices deployed via a wireline.
